(19) United States
(12) Patent Application Publication
(10) Pub. No.: US 2008/0050114 A1
(43) Pub. Date: Feb. 28, 2008

(54) METHOD OF DETERMINING AN OPTIMUM PATH IN AN OPTICAL TELECOMMUNICATIONS NETWORK

(75) Inventors: Pascal PECCI, Sainte Genevieve Des Bois (FR); Olivier Courtois, La Ville Du Bois (FR); Laurence Piriou, Bruyeres-Le-Chatel (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/845,274

(22) Filed: Aug. 27, 2007

(30) Foreign Application Priority Data
Aug. 28, 2006 (FR) 0653480

(51) Int. Cl. H04B 17/00; H04L 12/28

(52) U.S. Cl. 398/26; 370/351; 398/2; 398/25

(57) ABSTRACT

This invention concerns the field of telecommunication networks using optical fibres. The invention relates to a method of determining a connection path between two points in an optical network comprising several paths to connect said two points, each path comprising optical fibre spans and power amplifiers, said method comprising different steps depending on the degree of knowledge of network optical data. This data consists of the optical losses L_{I} in optical fibre spans, the maximum allowable input power IP into said spans and the maximum output power P_{A} from the amplifiers.

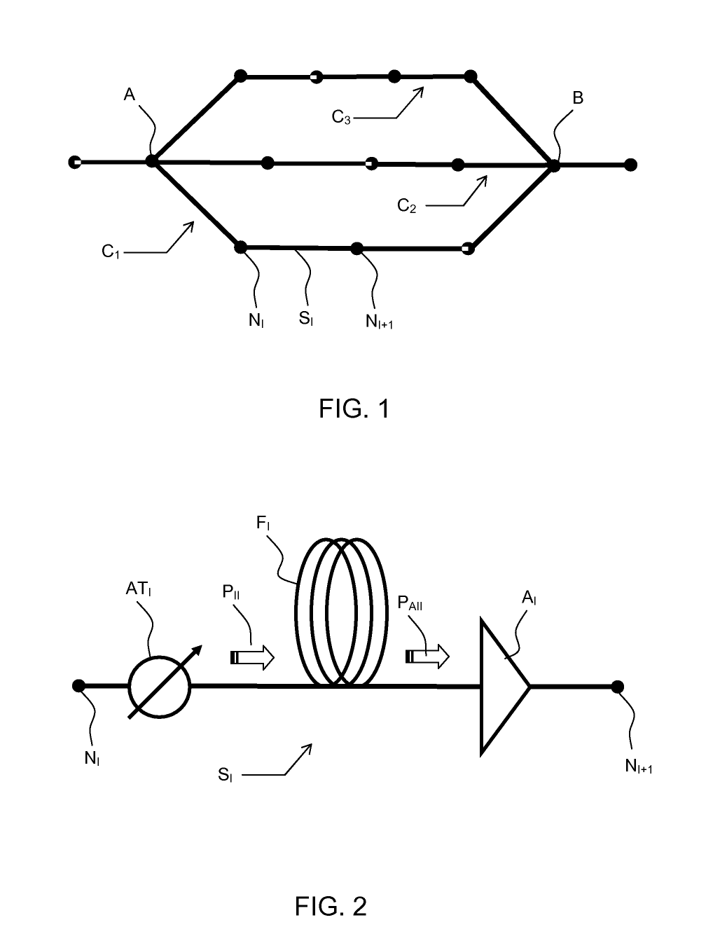

This invention concerns the field of telecommunication networks using optical fibres. A telecommunications network is conventionally composed of optical signal emission and reception nodes and optical fibre spans between the different nodes. There may be several possible paths for transferring a signal from one node to another in a telecommunications network. Thus on FIG. 1, node A can be connected to node B by using either path C1, path C2 or path C3, each path comprising nodes N_{I} and spans S_{I}. The choice of the best possible path is important. It will control the number and type of optical regenerators to be set up and the final performances of the span.

A path is defined by the following three main characteristics:
the number of spans;
the type of fibre making up each span;
the attenuation of each span expressed in dB.

The attenuation of the fibre and the length of the span control the level of optical losses L_{I} of the span. This level of losses is usually expressed in deciBels. The type of fibre also controls the maximum allowable input power IP into the optical fibre.

Optical amplifiers A_{I} are provided at the node so that a signal emitted by a node can reach the next node while remaining at acceptable power levels. One of the main characteristics of an optical amplifier is its maximum output power P_{A} that is usually expressed in dBm.

Therefore as shown in FIG. 2, a span S_{I} comprises mainly an optical fibre F_{I}, a variable attenuation device AT_{I} and an optical amplifier A_{I}. The optical signals passing through the span are shown by the arrows on this figure. The signal power at the input to the optical fibre is equal to P_{II}, and the signal power at the input to the optical amplifier is equal to P_{AII}.

When there are several possible paths to connect two nodes together, a criterion has to be determined for choosing the best of them. Simple elementary criteria can be used, for example such as the shortest path or the minimum number of spans connecting the two nodes. However, these rudimentary criteria are not sufficient to make a judicious choice between the different possible paths. In particular, if a selected path comprises a span with a large length of optical fibres, it is possible that the signal cannot be transmitted without excessive attenuation. One good criterion is to determine the Optical Signal to Noise Ratio (OSNR) on the different possible paths connecting two nodes and to select the path with the best OSNR.

However, not all network parameters are necessarily known for a large number of reasons related essentially to the network history. Thus, the method of determining a connection path between two points in an optical network according to the invention is based on several possible assumptions that depend on the extent of knowledge of the different network parameters.

More precisely, the purpose of the invention is a method of determining a connection path between two points in an optical network comprising several paths to connect said two points, each path comprising optical fibre spans and power amplifiers, said method being such that:

a) If only the optical losses L_{I} in the optical fibre spans are known, then the method comprises the following 3 steps:
Calculation of integration losses for at least a first and a second path between said two points;
Comparison between said losses;
Choice of the path that minimizes said losses;

b) If only the optical losses L_{I} in the optical fibre spans and the maximum allowable input power IP into said spans are known, then the method comprises the following 3 steps:
Calculation of the Optical Signal to Noise Ratio (OSNR) for at least a first and a second path between said two points assuming that the power injected into each span is equal to the maximum allowable input power;
Comparison between said signal/noise ratios;
Choice of the path that maximizes said signal/noise ratios;

c) If only the optical losses L_{I} in the optical fibre spans are known, the maximum allowable input power IP into said spans and the maximum output power P_{A} of the amplifiers are known, then the method comprises the following four steps:
Calculation of the real allowable power in the spans;
Calculate the signal to noise ratio for at least a first and a second path between said two points assuming that the power injected into each span corresponds to the maximum real allowable power;
Comparison between said signal/noise ratios;
Choice of the path maximizing said signal/noise ratios.

Advantageously in case a), a path is composed of N optical fibre spans, each span having an optical loss P_{I} expressed in dB, the integration losses IL in dB for said path are calculated using the following expression:

$$IL = 10 \cdot {Log}_{10} ( {\sum }_{i = 1}^{N} {10}^{Li / 10} ) .$$

Advantageously in case b),
a path composed of N optical fibre spans, each span having an optical loss L_{I} expressed in dB, the integration losses IL in dB for said path are calculated using the expression

$$IL = 10 \cdot {Log}_{10} ( {\sum }_{i = 1}^{N} {10}^{Li / 10} ) .$$

the maximum allowable input power IP in an optical fibre is expressed in dBm, the maximum power P_{I} in the optical path is calculated using the expression P_{I}=IP−10.Log N;

The noise figure expressed in dB for a power amplifier is denoted NF, and the signal to noise ratio OSNR is expressed in dB per 0.1 nm, then said OSNR ratio is calculated using the expression OSNR=P_{I}−IL−NF+K, K where K is a constant expressed in dBm and the constant K is equal to approximately 58.

Advantageously in case c),
a path composed of N optical fibre spans, each span having an optical loss L_{I} expressed in dB, the integration losses IL in dB for said path are calculated using the expression

$$IL = 10 \cdot {Log}_{10} ( {\sum }_{i = 1}^{N} {10}^{Li / 10} ) .$$

The maximum allowable input power IP into an optical fibre and the maximum amplifier output power P_{A} are expressed in dBm and if C is the number of multiplexed channels transiting along the path, the maximum power P_{IFC} in the optical path is equal to IP−10.Log N or P_{A}−10.Log C, whichever is the least.

The noise figure expressed in dB for a power amplifier is denoted NF, and the signal to noise ratio OSNR is expressed in dB per 0.1 nm, then said OSNR ratio is calculated using the expression OSNR=P_{I}−IL—NF+K, where the constant K is equal to approximately 58.

The invention will be better understood and other advantages will become clearer after reading the following description given non-limitatively with reference to the appended figures, wherein:

FIG. 1 represents a part of an optical network comprising nodes and spans;

FIG. 2 shows a span between two nodes with an indication of the different elements making up this span;

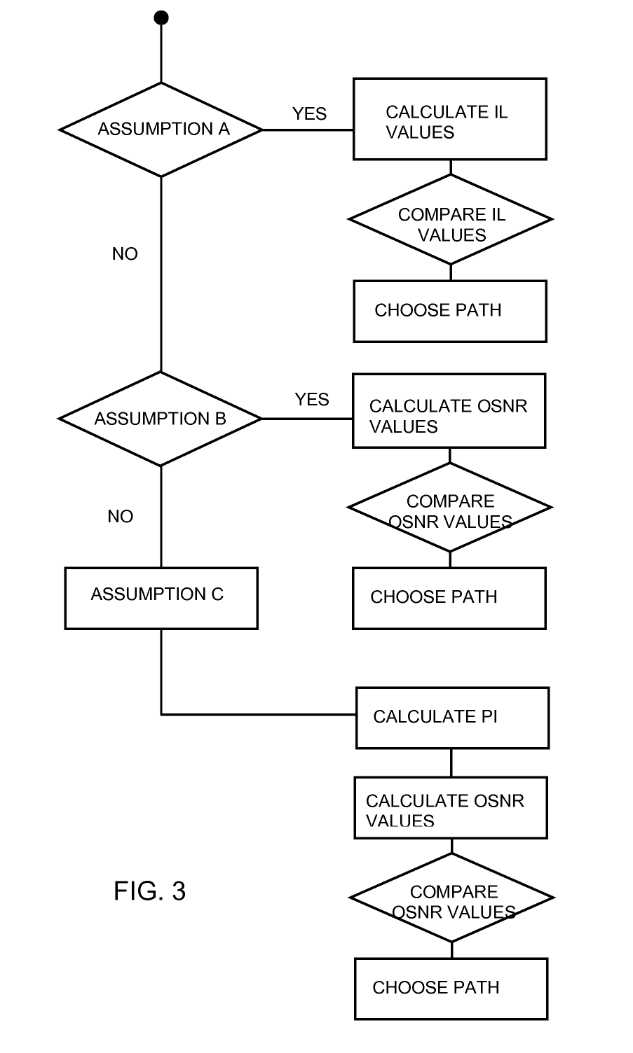

FIG. 3 shows the flowchart for the method according to the invention.

As already mentioned, the important parameter characterising the path between two nodes is the signal to noise ratio or OSNR. For a span S_{I}, the OSNR_{I} is given by the optical amplifier A_{I} of the span. The signal/noise ratio is conventionally calculated for a spectral band B_{f} with a width of 0.1 nanometres. This spectral width is equal to the wavelength of 1550 nanometers, at a frequency width of 12.5 GHz.

The OSNR_{I} is calculated in dB. Its expression is equal to:

OSNR_{I}(dB/nm)=P_{AII}(dBm)−NF_{AI}(dB)+K Equation 1
where P_{AII}: Input power of the optical amplifier A_{I}
NF_{AI}: Noise figure of the optical amplifier A_{I}
K: constant equal to −10.Log(h.v.B_{f}) where h=Planck's constant and v=optical frequency of the signal.

For optical telecommunications applications operating at a wavelength of 1550 nanometers, K is equal to about 58.

With optical losses for the optical link equal to L_{I}, the input power P_{AII} of the optical amplifier A_{I} is equal to:

P_{AII}(dBm)=P_{II}(dBm)−L_{I}(dB) Equation 2
where P_{II}: Input power in span L_{I}

Consequently, the OSNR_{I} is also given by substituting the expression for the input power P_{AII} given by equation 2, in equation 1:

OSNR_{I}(dB/nm)=P_{II}(dBm)−L_{I}(dB)−NF_{AI}(dB)+K Equation 3

In the following equations, to simplify the presentation, the different units will no longer be indicated, since the powers are all expressed in dBm and the attenuations in dB.

The signal to noise ratio OSNR for a path comprising N spans S_{I} each with a signal to noise ratio OSNR_{I} is equal to:

$$1 / OSNR = {\sum }_{i = 1}^{N} 1 / {OSNR}_{I}$$

which can also be written in the following form:

$$OSNR = 10 \cdot {Log}_{10} ( {\sum }_{i = 1}^{N} {10}^{( {P}_{II} - {L}_{i} - {NF}_{AI} + K ) / 10} ) \qquad Equation 4$$

Using this expression, and depending on knowledge of the optical telecommunications network, several assumptions can be made to simplify the calculation of the OSNR for an optical path.

Assumption A: Only optical losses L_{I} in optical fibre spans are known.

In this case, it can be considered that:
the input powers P_{II} in each span S_{I} are identical and equal to P_{I};
the noise figures NF_{AI} of optical amplifiers A_{I} are identical and equal to NF_{A}.

Equation 4 can then be written:

$$OSNR = {P}_{I} - {NF}_{A} + K - 10 \cdot {Log}_{10} ( {\sum }_{i = 1}^{N} {10}^{{L}_{I} / 10} ) \qquad Equation 5$$

that can be put in the form:

OSNR=K_{A}−IL
where K_{A} is a constant independent of the path chosen
and

$$IL = 10 \cdot {Log}_{10} ( {\sum }_{i = 1}^{N} {10}^{Li / 10} ) .$$

is dependent on the path chosen and is equal to the integration losses of the path.

Consequently, in assumption A, the signal to noise ratio can be optimised by choosing the path with the lowest integration losses IL, said losses being calculated using the expression in equation 5.

Assumption B: The optical losses L_{I} in optical fibre spans are known, together with the maximum allowable input power IP in said spans.

In this case, we can write:

P_{I}=IP−10 Log N Equation 6

Substituting the expression for P_{I} given in equation 6 into equation 5, we obtain:

$$OSNR = IP - 10 \cdot Log N - {NF}_{A} + K - 10 \cdot {Log}_{10} ( {\sum }_{i = 1}^{N} {10}^{{L}_{I} / 10} ) \qquad Equation 7$$

Consequently, in assumption B, the path with the highest OSNR should be chosen, said OSNR being calculated using the expression in equation 7.

Assumption C: Optical losses L_{I} in optical fibre spans are known, the maximum allowable input power IP in said spans and the maximum output power P_{A} from the amplifiers are also known.

In this case, the input power into the optical fibres may be limited:
Either, as in the case of assumption B, by the maximum allowable input power IP;
Or by the maximum output power P_{A} from the amplifiers.

In the first case, the input power into the optical fibres is equal to:

P_{I}=IP−10 Log N Equation 6

In the second case, the input power into the optical fibres is equal to:

P_{I}=P_{A}−10 Log C Equation 8

with C: Number of multiplexed channels circulating in the optical fibre. In fact, in optical fibre spans, the signals are usually multiplexed either in time or spectrally so as to increase the throughput of the span. Therefore the power output by an amplifier is distributed on the C channels transmitted by the optical fibre.

Therefore for each path, we need to determine:
Firstly, the input power corresponding to the minimum of the expressions given by equations 6 and 8;
Secondly, this minimum being known, the corresponding signal to noise ratio using equation 5.

The three assumptions for the method according to the invention are summarized in the flowchart in FIG. 3. Obviously, the installation of this method in a calculator or in a computer for the purpose of automatically determining the best possible path will not introduce any particular technical problems.

This method has the advantage of making the best use of technical information about a telecommunications network and optimising the choice of a path as a function of knowledge of this information.

1. Method of determining a connection path between two points in an optical network comprising several paths to connect said two points, each path comprising optical fibre spans and power amplifiers, said method being such that:
a) If only the optical losses L_{I} in the optical fibre spans are known, then the method comprises the following 3 steps:
Calculation of integration losses for at least a first and a second path between said two points;
Comparison between said losses;
Choice of the path that minimizes said losses;
b) If only the optical losses L_{I} in the optical fibre spans and the maximum allowable input power IP into said spans are known, then the method comprises the following 3 steps:
Calculation of the Optical Signal to Noise Ratio (OSNR) for at least a first and a second path between said two points assuming that the power injected into each span is equal to the maximum allowable input power;
Comparison between said signal/noise ratios;
Choice of the path that maximizes said signal/noise ratios;
c) If the optical losses L_{I} in the optical fibre spans are known, the maximum allowable input power IP into said spans and the maximum output power P_{A} of the amplifiers are known, then the method comprises the following four steps:
Calculation of the real allowable power in the spans;
Calculation of the signal to noise ratio for at least a first and a second path between said two points assuming that the power injected into each span corresponds to the maximum real allowable power;
Comparison between said signal/noise ratios;
Choice of the path maximizing said signal/noise ratios.

2. Method of determining a connection path according to case a) in claim 1, characterised in that a path is comprising N optical fibre spans, each span having an optical loss P_{I} expressed in dB, the integration losses IL in dB for said path are calculated using the following expression:
$$IL = 10 \cdot {Log}_{10} ( {\sum }_{i = 1}^{N} {10}^{Li / 10} ) .$$

3. Method of determining a connection path according to case b) in claim 1, characterised in that:
a path comprising N optical fibre spans, each span having an optical loss L_{I} expressed in dB, the integration losses IL in dB for said path are calculated using the expression:
$$IL = 10 \cdot {Log}_{10} ( {\sum }_{i = 1}^{N} {10}^{Li / 10} ) .$$
the maximum allowable input power IP in an optical fibre is expressed in dBm, the maximum power P_{I} in the optical path is calculated using the expression: P_{I}=IP−10.Log N;
the noise figure expressed in dB for a power amplifier is denoted NF, and the signal to noise ratio OSNR is expressed in dB per 0.1 nm, then said OSNR ratio is calculated using the expression: OSNR=P_{I}−IL−NF+K, where K is a constant expressed in dBm.

4. Method of determining a connection path according to claim 3, characterised in that the constant K is equal to approximately 58.

5. Method of determining a connection path according to case c) in claim 1, characterised in that:
a path comprising N optical fibre spans, each span having an optical loss L_{I} expressed in dB, the integration losses IL in dB for said path are calculated using the expression:
$$IL = 10 \cdot {Log}_{10} ( {\sum }_{i = 1}^{N} {10}^{Li / 10} ) .$$
The maximum allowable input power IP into an optical fibre and the maximum amplifier output power P_{A} are expressed in dBm and if C is the number of multiplexed channels transiting along the path, the maximum power P_{IFC} in the optical path is equal to IP−10.Log N or P_{A}−10.Log C, whichever is the least;
The noise figure expressed in dB for a power amplifier is denoted NF, and the signal to noise ratio OSNR is expressed in dB per 0.1 nm, then said OSNR ratio is calculated using the expression: OSNR=P_{I}−IL−NF+K.

6. Method of determining a connection path according to claim 5, characterised in that the constant K is equal to approximately 58.
